(19) United States
(12) Patent Application Publication
(10) Pub. No.: US 2002/0032723 A1
(43) Pub. Date: Mar. 14, 2002

(54) System and method for network-based automation of advice and selection of objects

(76) Inventors: Rani Johnson, Palo Alto, CA (US); Scott Van Valkenburgh, San Francisco, CA (US); Anatoly Pekelny, Redwood City, CA (US)

Correspondence Address: GARY CARY WARE & FREIDENRICH, 1755 EMBARCADERO, PALO ALTO, CA, 94303-3340, US

(21) Appl. No.: 09/862,978

(22) Filed: May 22, 2001

Related U.S. Application Data
(60) Provisional application No. 60/206,122, filed on May 22, 2000.

(51) Int. Cl. G06F 15/16; G06F 17/30

(52) U.S. Cl. 709/203; 709/219; 707/10

(57) ABSTRACT

A advice and search system and method in which a user is prompted to complete a profile, which the system understands and uses to trigger applicable rules in a knowledge matrix. The triggered rules are summarized to exclude conflicts and determine the output characteristic values (which define the optimal characteristics). In conjunction with the preset categorized, output characteristic searching order, and with output characteristic passing standards, these output characteristic values are fed into the searching schema, generating an individualized search engine for each distinct profile. This search engine queries the characterized inventory database ultimately resulting in prioritized inventory selections (again unique to each profile).

### RELATED APPLICATIONS

The present application claims priority under 35 U.S.C. §119(e) from provisional application No. 60/206122 filed May 22, 2000.

### TECHNICAL FIELD

The present invention is directed generally to automated advice and selection, and more particularly to a method and apparatus which is able to quickly and efficiently process a large number of rules, based upon a user supplied profile, to provide a categorized set of recommendations and selection criteria, and also to select objects in an efficient and rapid manner from a large inventory of possible objects based upon the categorized set of selection criteria.

### BACKGROUND

Although the present invention will be described in the context of a fashion example, it is to be understood that the concepts and techniques described in this application are applicable to a wide variety of situations in a variety of fields. There is no intent by use of an example in the fashion area to limit the scope of the inventions claimed in this application. It is believed that describing the present invention in the context of a fashion example will render the invention more easily understood, the fashion context being more generally familiar, but nonetheless as complex and variation-intensive as more technologically advanced scenarios.

Dressing oneself is not always easy. Many questions typically run through a person's mind while trying to select clothing. Does this make me look fat? What color shoes go with this outfit? Is this still in style? What should I wear? Tens of thousands of these questions are sent to style columnists across the nation every day, while hundreds of thousands more are asked of retail salespeople. But millions go completely unanswered, resulting in the inquirer choosing apparel that is not right for their body, for their color tones, or for the event they are attending.

Several attempts have been made to connect apparel customers with retailers via the World Wide Web (“Web”). High customer acquisition costs and poor customer retention rates have resulted in disappointing returns for most consumer apparel websites. These poor returns are primarily due to consumers having difficulty in locating precise items, the inherent inability to touch or try on garments, a cumbersome, delivery-based return/exchange process, and the lack of personal assistance. While online apparel shopping offers many unique, interactive possibilities, it can never fully replace visiting a store to shop for clothes.

Most consumer apparel websites are backed by companies that stock and ship apparel directly. These companies do not offer sophisticated, automated advice, nor have robust search capabilities. Many magazines and webzines offer style opinions to their niche audience. However, such advice is neither fully personalized nor comprehensive.

Among the difficulties of offering sophisticated, automated advice is that conventional artificial intelligence methods and systems require sophisticated programming techniques, high performance server systems to process the artificial intelligence applications, and highly trained personnel to administer. The more sophisticated and detailed the user-supplied input, the more complex and computationally intensive the conventional artificial intelligence solution. Updating or maintaining the domain knowledge for such systems can prove to be arduous tasks.

For example, a conventional method for approaching the fashion advice problem is to use an extensive series of “if-then” statements to address each of the possible combinations of user requirements and clothing attributes. A drawback of such an approach its sheer size and complexity if all feasible combinations are to be handled.

It is therefore desirable to provide an artificial intelligence based-automated advice methodology and system which avoids the cumbersome knowledge representation and heavy computational requirements of conventional approaches, yet can accommodate detailed user requirements and a large number of possible variations in the characteristics of the possible choices. In a fashion context, this artificial intelligence based method and system closely duplicates a clothing and accessory style consultant, also known as a “personal shopper.”

### BRIEF SUMMARY OF THE INVENTION

The above and other problems and disadvantages of prior automated advice methods and systems are overcome by the present invention of a method, and apparatus therefor, of providing advice and forming criteria based on the advice for selecting objects out of an inventory of available objects. The formulated criteria are based upon user-supplied profile information, a set of object characteristics, and a set of rules which have been formed by associating a set of variations of the object characteristics with a set of variations of input variables. In accordance with the present invention, each variation in object characteristics is associated with each variation in input variables, and a priority is assigned to each such association to form a prioritized rule set. The user-supplied profile information is analyzed to select specific variations from the set of variations of input variables. The selected input variable variations are applied to the prioritized rule set to obtain a reduced set of prioritized rules. The reduced set of prioritized rules are processed to generate categorized output characteristic values which represent the advice and the criteria for selecting objects.

In a further aspect of the present invention, a method and apparatus are provided for selecting objects from an inventory of objects, each object being described by a set of characteristics and by a value for each characteristic in the set of characteristics, where, for a particular object the assigned values of the characteristics for that particular object are descriptive thereof. In accordance with the present invention, a set of desired characteristic values is formed. A branched path search schema is formed as a function of the desired characteristic values, output characteristic passing criteria, and supplied search order criteria. Objects from the inventory of available objects are evaluated according to the branched path search schema. The evaluated objects are then ranked according to how well the object traversed the branched path search schema.

The present invention provides a straight forward yet sophisticated methodology and structure for accommodating detailed user requirements and a large number of possible variations in the characteristics of the possible choices to provide a set of well-informed recommendations, while avoiding the heavy computational requirements of conventional approaches.

These and other advantages of the present invention will be more readily understood upon considering the following detailed description of the present invention, and the accompanying drawings.

### BRIEF DESCRIPTION OF THE DRAWINGS

FIG. 1 is a simplified functional block diagram of the advice engine and the object selection methodology of the present invention

FIG. 2 provides a more detailed functional block diagram of the advice engine processing in accordance with the present invention.

FIG. 3A and 3B provide a example of the kinds of user profile input data which might be provided in connection with the present invention, and a specific example in the fashion context.

FIGS. 4A to 4L provide examples of input variables, variations of such variables, and values assigned to such variations of input variables.

FIG. 5 illustrates the conversion process by which the user profile input data is used to select particular input variable values.

FIG. 6 is an example of a pre-ordered input variable array which is the result of the conversion process illustrated in FIG. 5.

FIG. 7 illustrates a theoretical knowledge matrix and the relationship between input variables, input variable variations, object characteristics and variations of object characteristics, and assigned priorities.

FIG. 8 illustrates the use of the pre-ordered input variable array of FIG. 6 to trigger portions of the matrix which are related to the input variable variations set forth in FIG. 6.

FIG. 9 is an illustration of a theoretical reduced matrix in accordance with the present invention, and demonstrates the relationship between input variables, the object characteristics, and the associated priorities.

FIGS. 10A to 10Q illustrate object characteristics and variations of such characteristics in the fashion context in the form of pre-defined user input and garment characteristic categories.

FIGS. 11A to 11D illustrate a reduced matrix and output characteristics for the problem of fashion, and the processing of input variable weights, assigned priorities, and exclusions rules in accordance with the present invention.

FIG. 12 provides a more detailed functional block diagram of the object selection methodology in accordance with the present invention.

FIGS. 13A to 13E illustrate the use of output characteristic values, search order, value and passing standards in accordance with the present invention for the problem of fashion.

FIGS. 14A to 14D illustrate a branched search engine generated for the output characteristic searching order, values and passing standards set forth in FIGS. 13A to 13E.

FIGS. 15A and 15B provide an example of a characterized inventory database for the problem of fashion.

### DETAILED DESCRIPTION OF THE INVENTION

In the specific fashion example described, a system and method are described for apparel advice automation over a network, such as the World Wide Web (“Web”).

User of websites typically browse through websites by “clicking” with a computer mouse through a series of strategically organized hyperlinks. On the other hand, consumers of retail outlets browse through apparel by physical walking through “Brick & Mortar” stores that stock the apparel. A system that provides a connection between website users and physical retails stores is preferably referred to as a “Click & Mortar” model. The apparel advice automation described herein will provide the apparel industry with an improved Click & Mortar model for apparel, an extremely “high-touch” product.

At least five primary tools are described to increase apparel websites' “stickiness” and personalization, facilitate specific product searches, drive traffic into Brick & Mortar stores, and create a centralized place for consumers to search for clothing at local outlets. These tools preferably include:

1. An “expert” that supplies highly personalized, occasion specific clothing advice, equal to or better than that of a professional style consultant, which then allows for the purchase of specific clothing choices based on the advice;

2. An industry standard XML ontology and centralized database of detailed product features allowing for extremely specific product searches;

3. Customizable consumer portal software and email notifications that are regularly updated with new inventory, style and seasonal recommendations;

4. A turnkey solution that allows consumers to place an item on hold at a local store to be tried on before purchase, or (depending on the retailer's needs) purchase a garment online then pick it up at a local store;

5. A “portal” based on the aforementioned technologies, the portal allowing consumers to search through a database of products rather than individual stores. This portal can include sticky features such as gifting advice, daily outfit assessments, garment design & find, continually updated information on fashion trends, feedback to designers on their latest lines, discussion groups, chat rooms, expert style columnists, style testimonials, fashion police citations, user's style photo gallery, streaming video of runway shows, and more.

The “expert” identified above will be the primary focus of the detailed description provided herein.

In the fashion example, a “Website” is provided which is centered around the “expert” advice method and apparatus, and is preferably configured to produce comprehensive written reports with illustrations of recommended attire. Clothing experts provide expert information to a database associated with the “Website.” These clothing experts work directly with designers to display actual examples of clothing articles in the advice reports. As inventory is added, an extensive database of well-described products is developed, allowing for precise searches of specific products.

In one version, links are provided to designers' website. Major fashion magazines are engaged by offering free advertising on the Website in exchange for positive articles about the Website. As the Website brand, traffic and credibility builds, retailers may be approached to fulfill the demand generated for the products displayed. Items are delivered through a retailer's existing shipping infrastructure, or a fax is sent to a local store's customer service department to inquire about availability.

To complete the overall solution, appropriate database technologies are utilized for robust integration of local retail inventories with the Website. Ultimately, an application service provider (“ASP”) sells the complete service and/or individual technologies to apparel e-tailers, portals, and style webzines. Once registered with a personalized profile, consumers will find their profile on all sites using technology of the present invention.

The present invention may be used in connection with marketing efforts to target people discontent with their physical appearance or with their social/romantic status. The technology may also be used to target online body-conscious women, and single men. Combined, these two groups represent 31 million people.

There are over 100 large apparel retailers in the U.S. along with thousands of smaller stores suitable for using technology of the present invention. Mid-range to high-end department stores, such are also suitable users.

Conceptually, in accordance with the present invention a user is prompted to complete a profile, which the system understands and uses to trigger applicable rules in a knowledge matrix. The triggered rules are summarized to exclude conflicts and determine the output characteristic values (which define the optimal characteristics). In conjunction with the preset categorized, output characteristic searching order and output characteristic passing standards, these output characteristic values are fed into the searching schema, generating in an individualized search engine for each distinct profile. This search engine queries the characterized inventory database ultimately resulting in prioritized inventory selections (again unique to each profile).

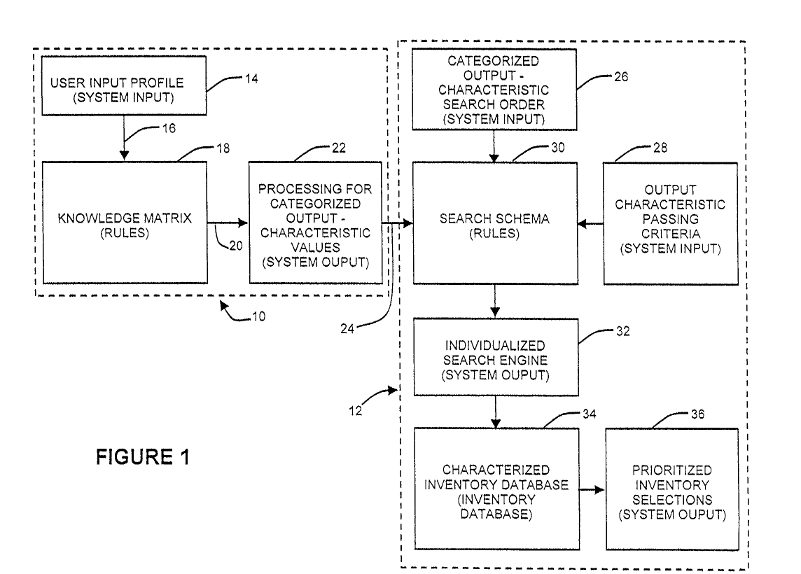

Referring to FIG. 1, the present invention will now be described in greater detail. The present invention has two distinct parts which can function independently of one another: an advice engine 10, and an object selection methodology 12.

Advice engine 10 takes in a user input profile 14, uses the information from the user input profile 14 to select input variables 16 which trigger rules in a knowledge matrix 18. In turn, these triggered rules 20 are evaluated and processed in a processing block 22. The result of the processing in block 22 is a set of categorized output characteristic values 24.

The object selection methodology 12 uses information such as the set of categorized output characteristic values 24, a search order 26, and passing criteria 28 in a search schema forming operation 30. The result of the search schema forming operation 30 is a branched path search engine 32 which can be individualized or customized to a particular user or set of circumstances.

Characterizations of objects, such as fashion items which have been characterized and stored in an inventory database 34, are subjected to the branched path search engine 32, evaluated, and ranked. The result is a prioritized inventory selection list 36, which is the output of the object selection methodology and system 12.

Advice Engine—Criteria Formation

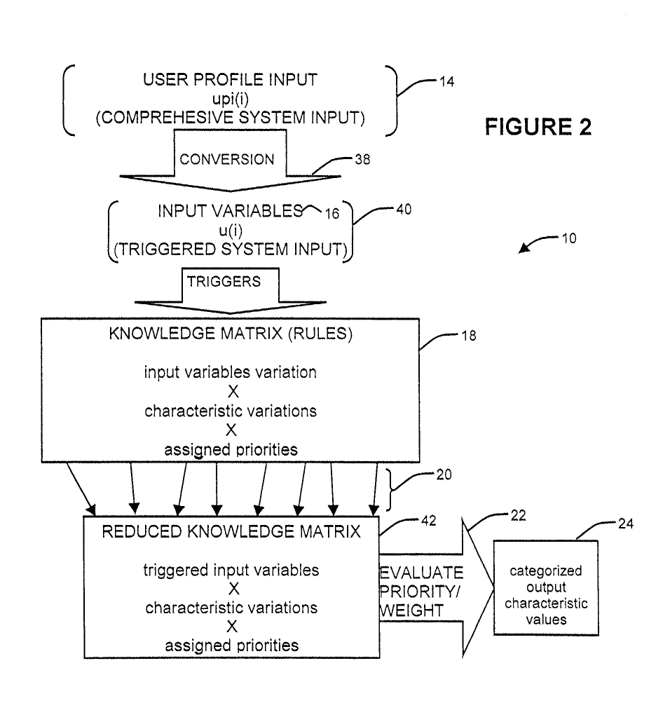

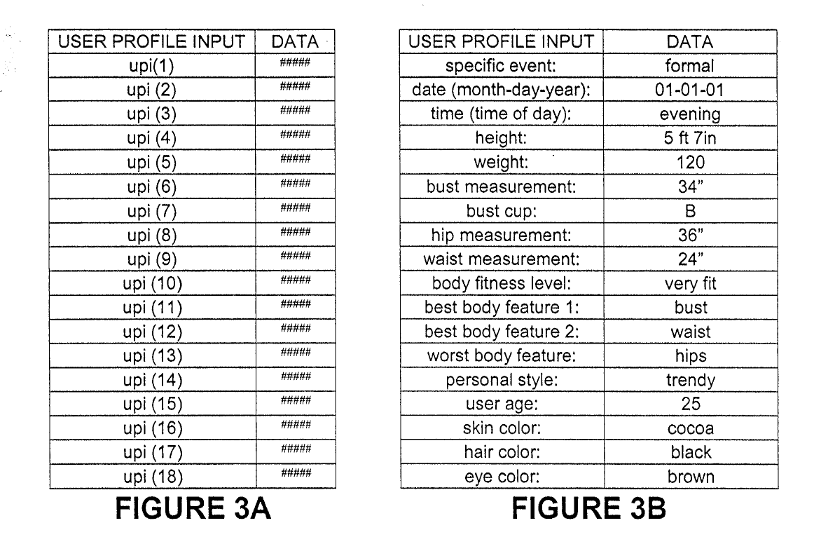

Additional details about advice engine 10 are provided in FIG. 2. The user profile input 14 can be an array of information upi(i) as in FIGS. 3A and 3B, which will be described in detail below. The user profile input 14 is converted in a conversion process 38 into the select input variables 16 which are formed into a pre-ordered input variable array 40.

In order to form the pre-ordered input variable array 40, the conversion process 38 uses a set of input variables each of which has a number of defined variations. Depending upon information supplied in the user profile input 14, different variations of the input variables will be identified.

The pre-ordered input variable array 40 is applied to knowledge matrix 18 to trigger corresponding portions of the matrix. Knowledge Matrix 18 associates the possible variations of the input variables with the possible variations of the characteristics, and assigns priorities to each combination of input variable variation and characteristic variation.

These triggered portions or rules 20 of knowledge matrix 18 are used to form a “reduced knowledge matrix” 42. The “reduced knowledge matrix” 42 is then evaluated (see function 22, FIG. 2) to generate the “categorized output characteristic values” 24.

FIG. 3A illustrates an example of an array of user profile inputs, with eighteen (18) elements or pieces of information making up the array. It is to be understood that the number of elements in the array will be determined by the requirements of the particular application and the level of detail desired for the particular advice task.

FIG. 3B provides an example of the user profile input array for the fashion example. As can be seen from this example, the information supplied by the user is of the type which will aid in the selection of the objects of interest, in this case garments and fashion accessories. For example, the nature of the specific event, whether, formal, informal, or other, will impact the kinds of garments which would be appropriate. The time of day, as well as the date of the event, will also dictate whether a light weight or heavier material is most suitable. Information about the user's body, both objective and subjective are, also requested. In other applications, such as advice on consumer electronics selection, or other retail scenarios, the information to be supplied by the user will be different. For example, for the consumer electronics scenario, for audio reproduction equipment, the user will be asked about listening preferences, room sizes, music sources, and the like.

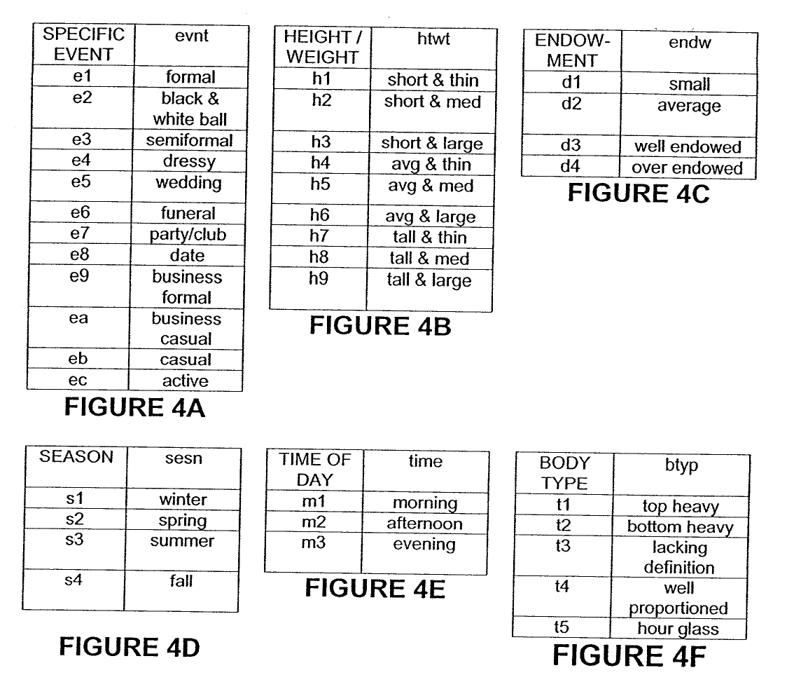

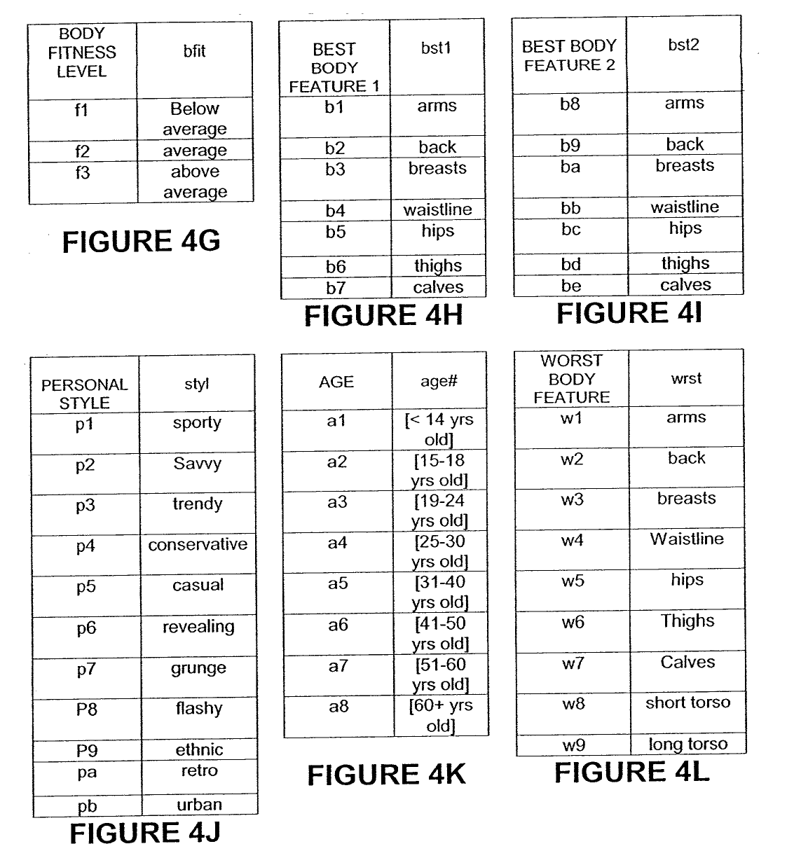

FIG. 4A to 4L illustrate possible input variables for the fashion example, and the possible variations which have been defined for each such variable. For example, FIG. 4E corresponds to the input variable of “time” and defines three variations: m1—morning; m2—afternoon; and m3—evening. FIG. 4K defines the variable age, “age#,” and defines eight (8) variations. Some input variables, such as height/weight, “htwt,” represent combined or related profile information, while others, such as body type, “btyp,” include a subjective element.

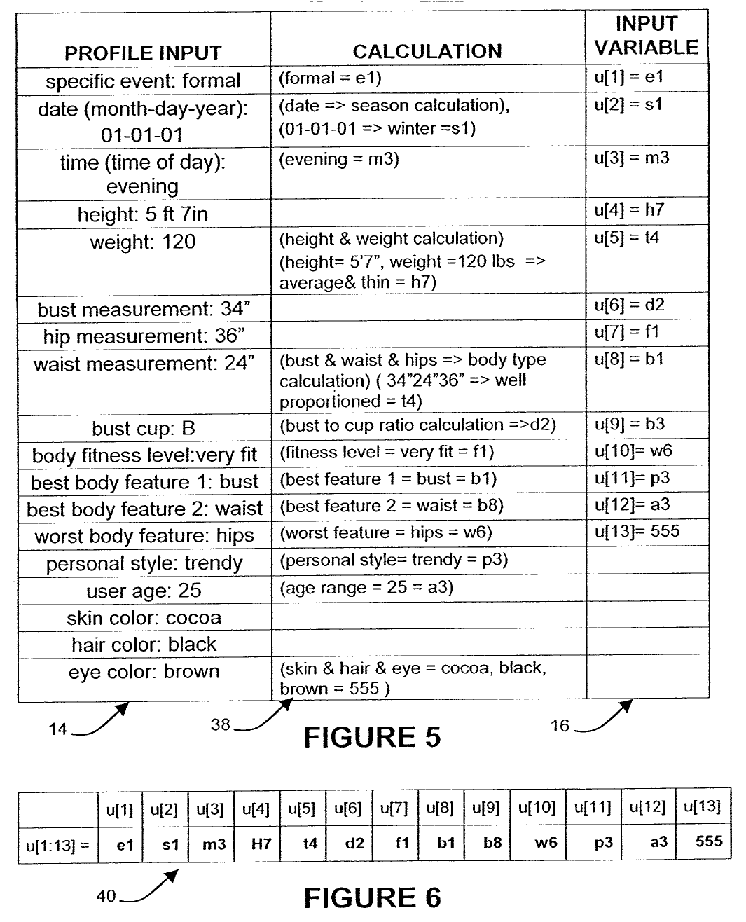

FIGS. 5 and 6 illustrate how the user profile information obtained in FIGS. 3A and 3B are subjected to several calculations that convert it into pre-defined categories, FIGS. 4A to 4L, which are in turn assembled into a pre-ordered input variable array, u(j), FIG. 6. In the fashion example, illustrated in FIG. 6, the pre-ordered input variable array has thirteen elements.

In FIG. 5, the user profile input is provided in the left most column. The center column illustrates the calculations. The right-most column illustrates the calculated “input variable” variation. It can be seen, for example, that input variable u[5] has been set equal to “t4.” From FIG. 4F it can be seen that “t4” is one of the variations of the body type, “btyp,” input variable. In FIG. 4F, “t4” corresponds to the “well proportioned” variation. Referring back to FIG. 5, it can be seen that the “well proportioned” calculation was made using the user profile input of “bust” and “waist” and “hips.” Other calculations and the user profile input used for such calculations are shown in FIG. 5.

The pre-ordered input variable array of FIG. 6 is used to trigger applicable rules in the knowledge matrix 18, see FIG. 1. More particularly, the input variable array triggers analogous columns in the knowledge matrix 18, an extensive, weighted, 2 dimensional knowledge matrix that supports all feasible input conditions. In use, this knowledge matrix is populated with real numbers that represent prioritized rules(prᵢⱼ), used in calculating the output characteristic value (ocᵢ) for the expert system. Each column in the knowledge matrix cab be weighted by a variable multiplier (wᵢ).

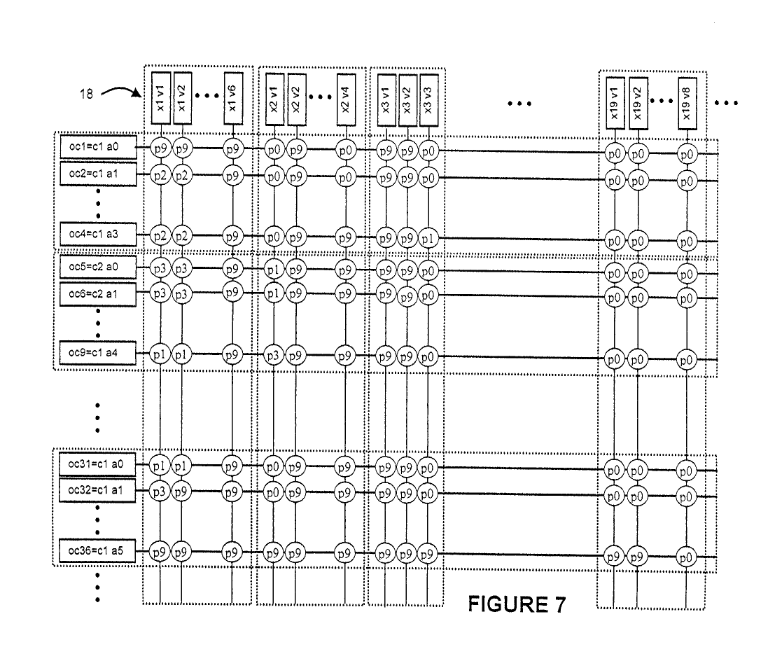

Referring to FIG. 7, a simplified, conceptual illustration of the knowledge matrix 18 is provided. It is to be noted that the knowledge matrix 18 is arranged in groups of columns and groups of rows. Each group of columns represents an input variable, and the variations for that input variable. Each group of rows represents a characteristic and the variations for that characteristic. At the intersection of each column and row is a “priority” The priority is assigned to indicate the importance of that combination of the particular input variable variation and characteristic variation, with respect to other variations of that characteristic.

For example, in FIG. 7, the first group of columns represents an input variable x1, and variations of v1 through v6 of input variable x1. The first group of rows represents characteristic c1, and variations a0 to a3 of characteristic c1. The priority assigned to the combination of x1v1 and c1a0 is a low “p9” On the other hand, the priority assigned to the combination of x1v1 and c1a1 is a relatively high priority of “p2” In this manner, a large number of combinations of input variable variations and characteristic variations are represented in the knowledge matrix 18, and a priority is assigned to each such combination.

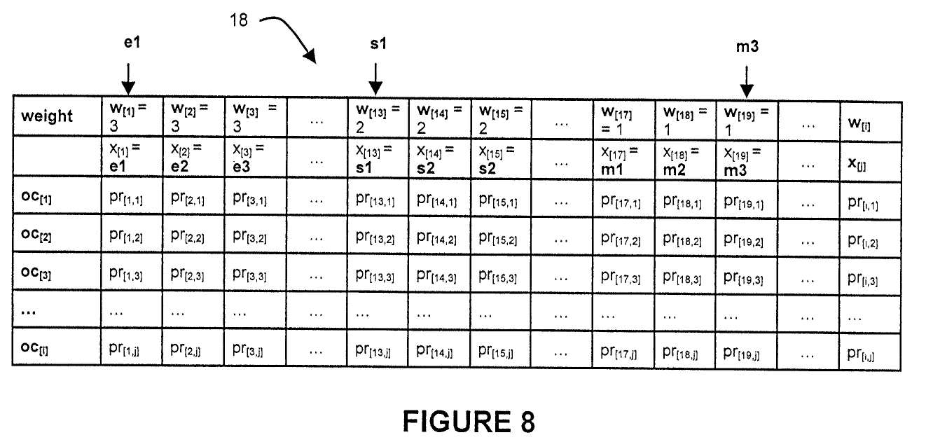

FIG. 8 illustrates the knowledge matrix 18 of the present invention applied to the fashion example, and the manner in which PATENT triggers from the pre-ordered input variable array 40 of FIG. 6 are used to select certain columns from the knowledge matrix 18 for further processing. It is to be noted that the embodiment of the knowledge matrix 18 shown FIG. 8 also includes a row which assigns “weights” to each of the input variable variations. As will be described in greater detail herein below, these “weights” can be changed which in turn will affect selection outcome.

Three of the triggers, or input variables, from FIG. 6, e1, s1, and m3, are shown in FIG. 8. These “trigger” respective columns in the knowledge matrix 18. These and the other “triggered” columns are used to form the “reduced knowledge matrix” 42. See FIG. 2. In other words, The triggered columns in the knowledge matrix form a reduced matrix that is likewise affected by variable multiplier. The applicable, non-excluded, prioritized rule values in the reduced matrix are averaged to generate the final output characteristic values. These values dictate which output characteristic is most favorable.

The following equation characterizes the relationship between the knowledge base matrix, input variable and output characteristic array:

$${oc}_{i} = \frac{{\sum }_{i = 1}^{N} ( {pr}_{ij} ∈ S ) * {W}_{j}}{{\sum }_{i = 1}^{N} {pr}_{ij} ∀ ( {pr}_{ij} ∉ S )}$$

uⱼ=(triggered) system input variable array

xᵢ=(comprehensive) system input variable array

prᵢⱼ=priority rule values for the knowledge (and reduced) matrix

wᵢ=weighted multiplier

S∈R[1.0 . . . 3.0]=predefined range of real numbers that dictate priority in the knowledge matrix 18. Note that for the purposes of the fashion example, the range of real numbers from 1.0-3.0 dictate an applicable, non excluding priority value. The real number 0.0 denotes a ‘don't care’ or ‘no effect’ priority. The real number 9.0 indicates ‘exclude this characteristic entirely ’

ocᵢ represents the sum of all triggered prioritized rules prᵢⱼ in the row (i), multiplied by the weights wⱼ of each triggered column uⱼ. The result of which is divided the number of triggered rows in the set S (that contain applicable rule values R[1.0 . . . 3.0])

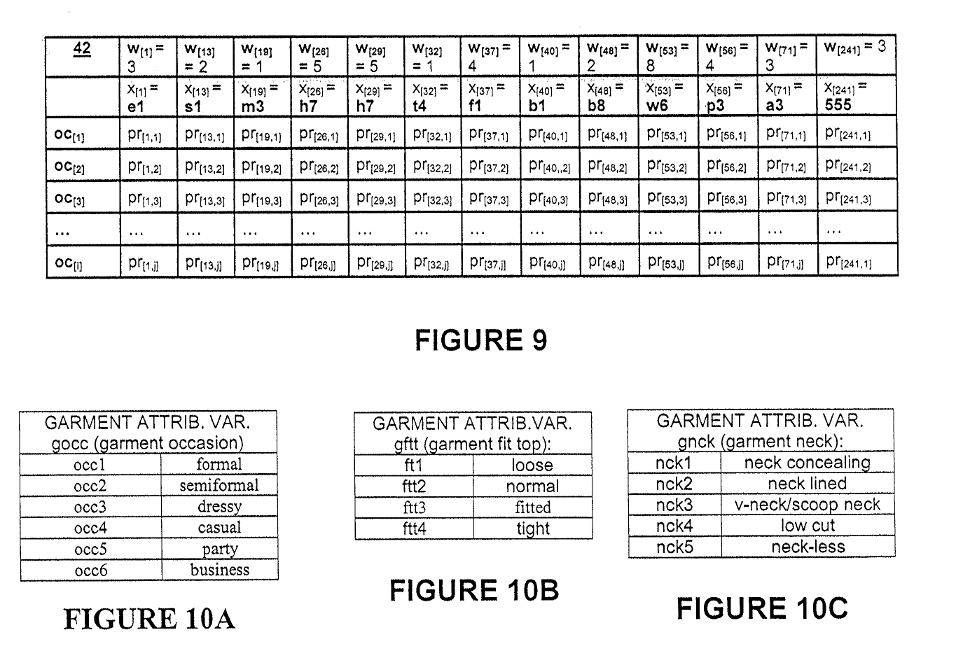

Turning to FIG. 9, a “reduced knowledge matrix” 42 is illustrated conceptually. Note that there are fourteen (14) columns, thirteen (13) of which correspond to the input variables from the pre-ordered input variable array 40. While the number of columns in reduced knowledge matrix 42 are reduced in comparison to knowledge matrix, 18 it is to be noted that the full compliment of characteristic variations (rows) have been preserved.

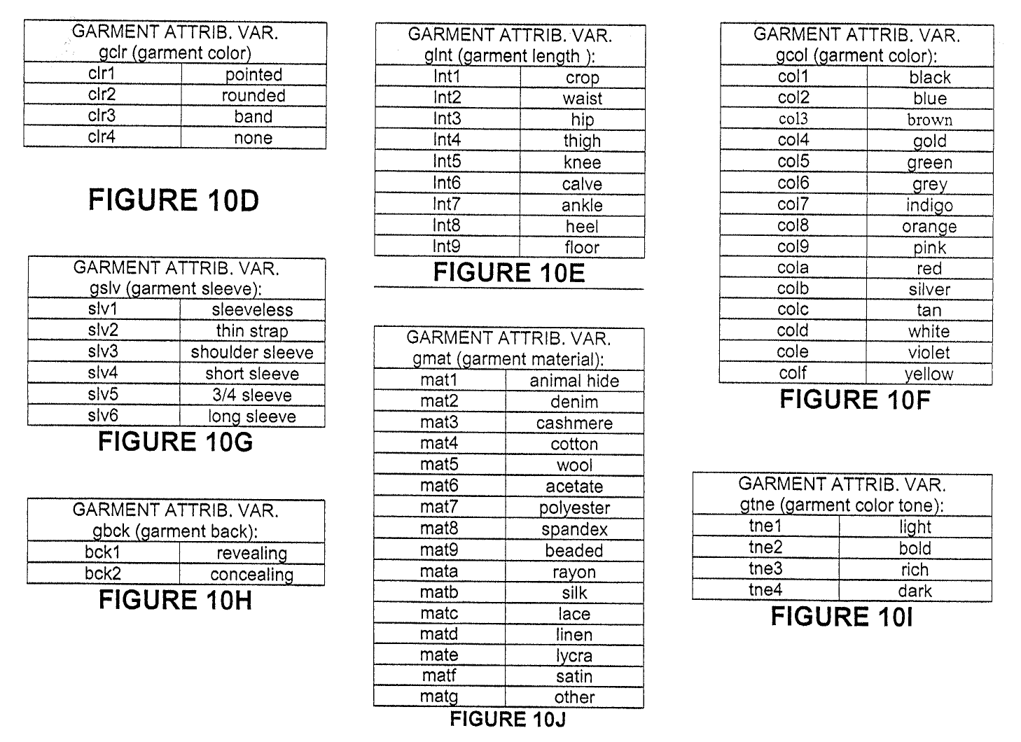

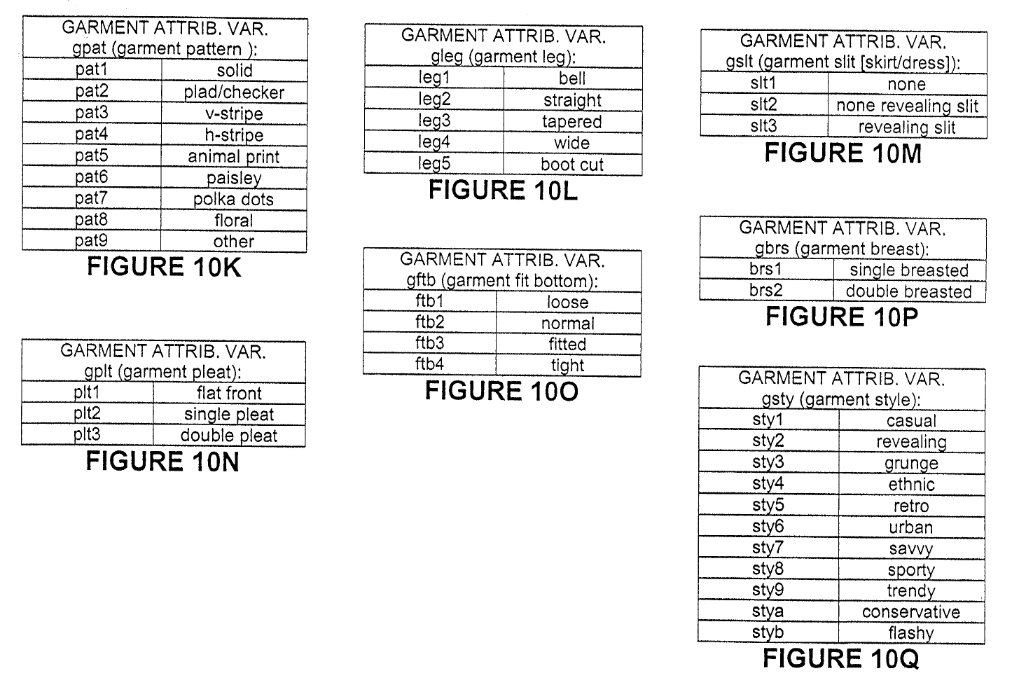

FIGS. 10A to 10Q illustrate for the fashion example, the characteristics of the garments of interest, and their variations, which are used to populate the rows of the knowledge matrix 18. For example, FIG. 10B represents the “fit” for a garment “top,” and uses the symbol “ft.” Possible variations of the “garment fit top” characteristic include “ft0=loose and ftt2=fitted.

FIG. 10J specifies the “garment material” characteristic, and identifies variations such as “mata”=silk; “mat4”=wool; and “mat9”rayon. Similarly, FIG. 10K corresponds to the “garment pattern” characteristic, and has pattern variations including “pat0”=solid; “pat5”=paisley; and “pat8”=other.

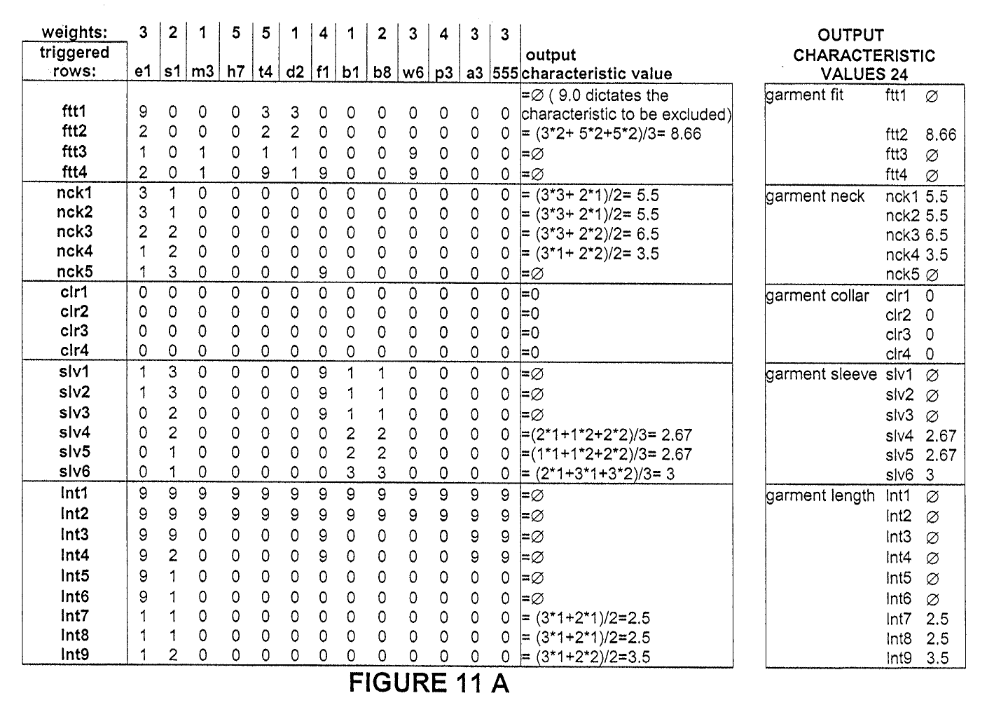

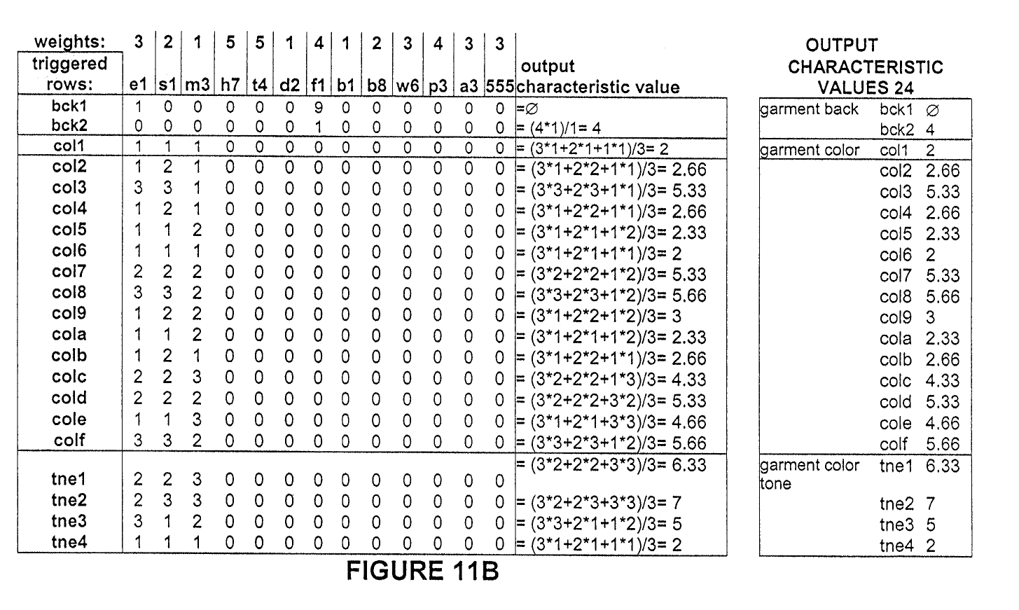

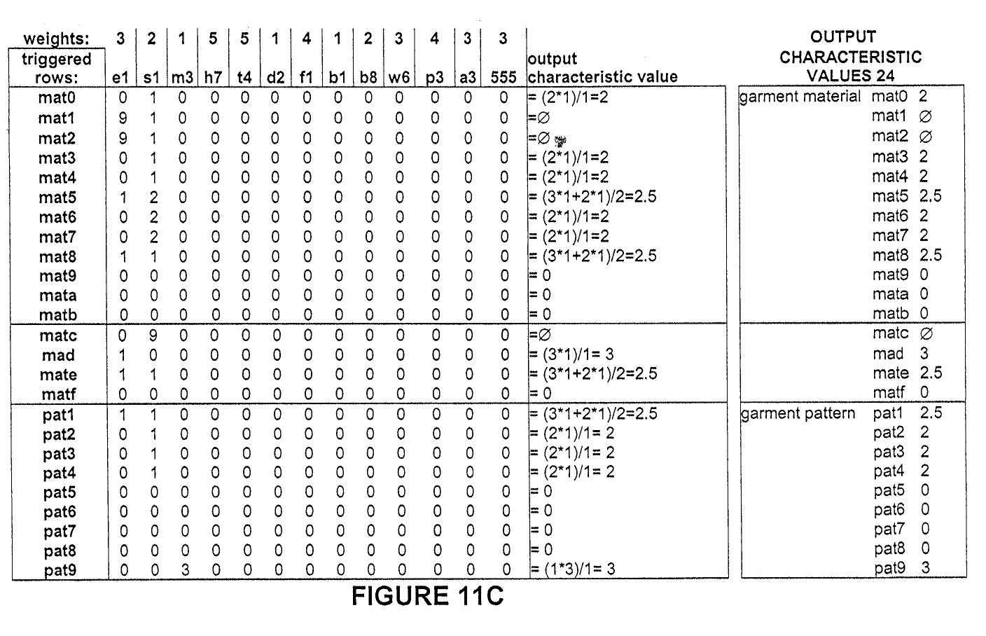

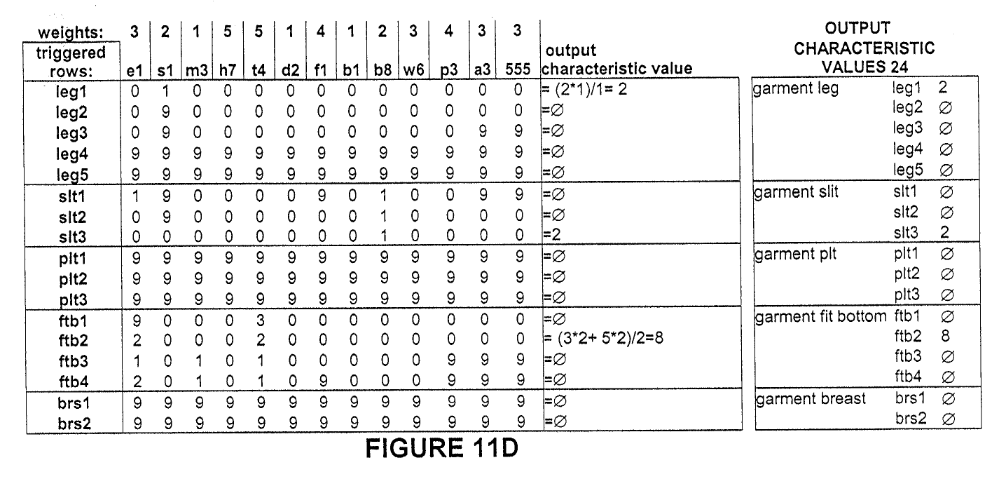

FIGS. 11A to 11D illustrate a reduced knowledge matrix 42 which contains working numbers for the fashion example. Also illustrated in FIGS. 11A to 11D is the processing which is performed using the listed priorities and the column weights to obtain output characteristic values 24.

Taking the “nck1” row as an example, it can be seen that the processing includes multiplying the weight for a column by the priority assigned to the row/column combination, and then repeating the operation for all columns, summing the products, and then dividing the sum by the number of non-zero products. In the case of the “nck1” row, there are two non-zero products which result in a 5.5 value for the “nck1” characteristic. From FIG. 10C it can be seen that the “nck1” characteristic variation corresponds to a “neck lined” garment characteristic.

In a similar manner, for the “slv6” row the value for the “slv6” characteristic is determined to be “3.” From FIG. 10G it can be seen that the “slv6” characteristic variation corresponds to a “long sleeve” garment feature.

It is to be noted that when the value of “9” appears as a priority for any of the characteristics, that characteristic is excluded from the output characteristics. Thus, in FIGS. 11A to 11D, it can be seen that a number of the characteristics are excluded because a “9” appears in at least one of the columns, and such exclusion in indicated by an “excluded” symbol, Ø.

The right-most column in FIGS. 11A to 11D represents the categorized output characteristic values 24 for the fashion example, which is a result produced by the advice engine in accordance with the present invention. In particular, for the fashion example, this result provides a list of garment characteristics, possible variations for each garment characteristic, and a prioritization for such features and variations. The resulting output characteristics are arranged into predefined categories. The output characteristic in each category with the lowest overall value is defined as optimal. Successively, the remaining non-excluded output characteristics are prioritized accordingly.

Therefore, for the user whose user profile was provided for the fashion example of FIGS. 11A to 11D, the garment fit should be “fft2” or normal with a fairly low priority of 8.6; the highest priority variation for garment neck is “nck4,” or low-cut with a priority of 3.5; the garment leg should be “leg1” or “bell” with a priority of 2; and so on. See FIGS. 10A to 10Q.

It is to be noted that a number of different weights have been applied to the columns in the fashion example of FIGS. 11A to 11D. In this example, the lowest weights represent input variables which are to have the highest impact on the outcome. For example, input variables m3, d2, and b1 have been assigned weights of “1.” From FIGS. 4A to 4L it can be seen that these input variables correspond to: m3=time of day—evening; d2=endowment—average; and b1=best body feature—arms. Conversely, de-emphasizing weights of “5” were assigned to input variables “h7” and “t4,” which represent: h7=height/weight—tall and thin; and t4=body type—well proportioned.

Object Selection Methodology

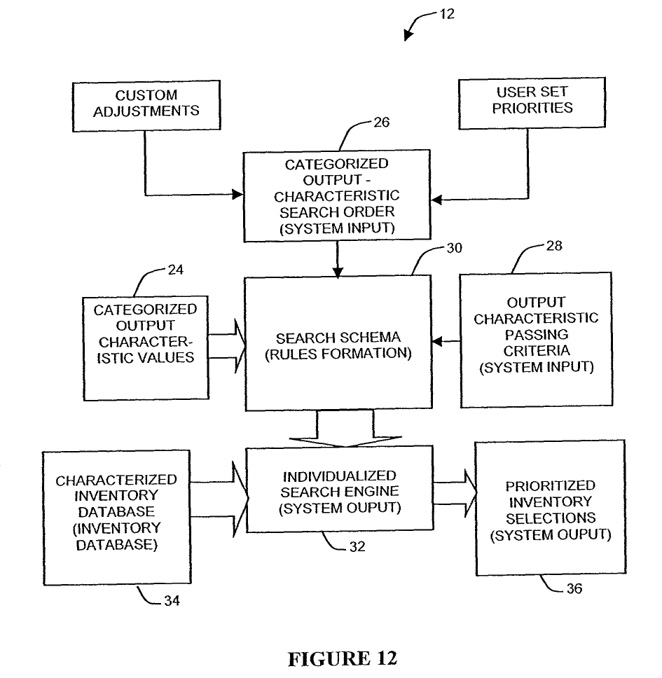

Referring to FIG. 12, the objection selection methodology of the present invention will now be described in greater detail. The searching schema utilized in this system is an ordered search. Its organization is dictated by the categorized output characteristic search order 26. This order can be either preset or determined by utilizing the user profile that accesses an additional knowledge base. The output characteristic passing standard 28 sets the maximum output characteristic value permissible for progression to the next category (as dictated by the categorized output characteristic search order 24) in the search schema.

Once an individualized search engine 32 is fashioned from the above information, objects or items from the characterized inventory database are subjected to the individualized search engine 32. As an object progresses through the individualized search engine 32, a score is kept of how well the item satisfies the search criteria. For example, the score might be incremented for each level successfully passed, and decrement by a like amount for each level not successfully passed.

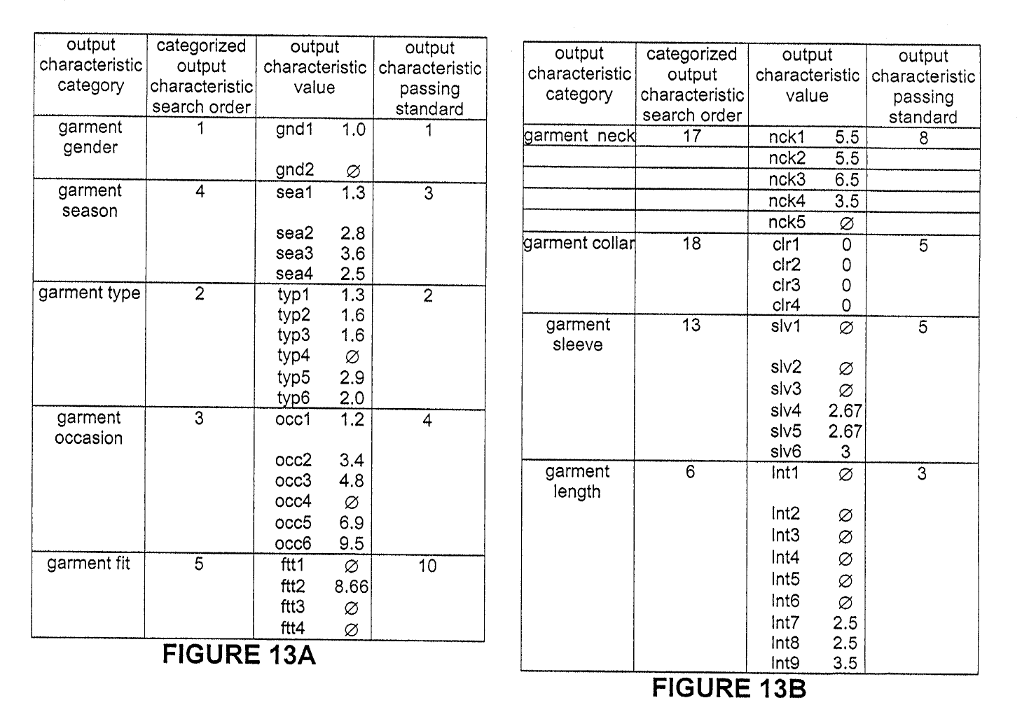

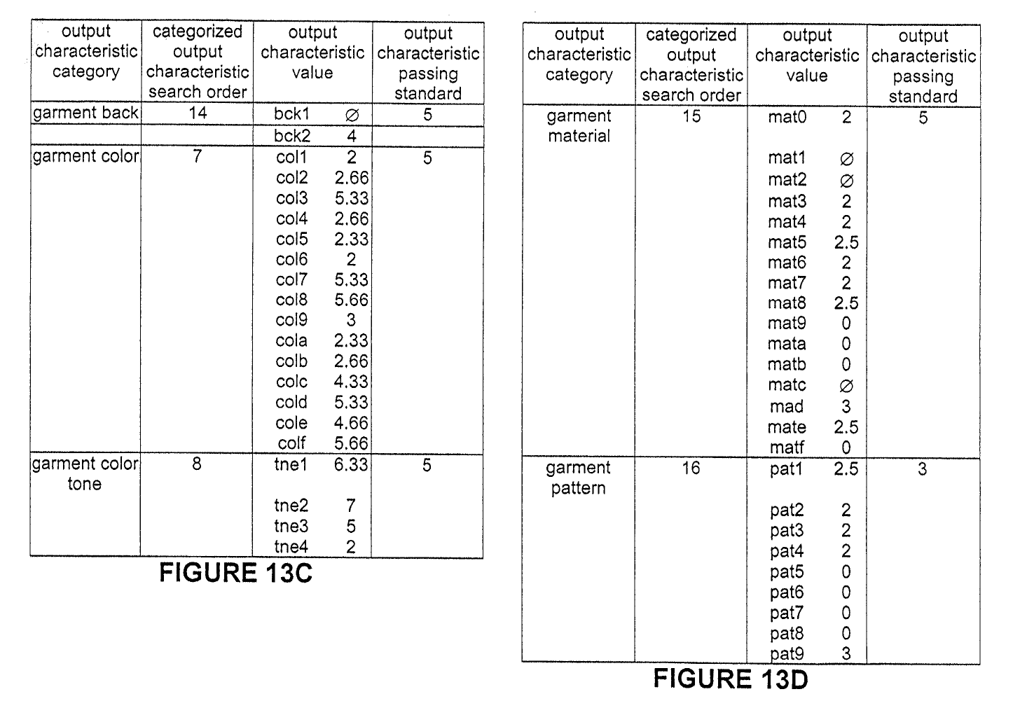

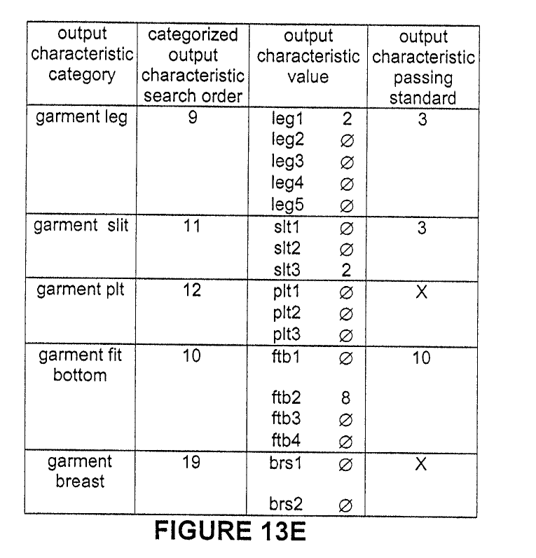

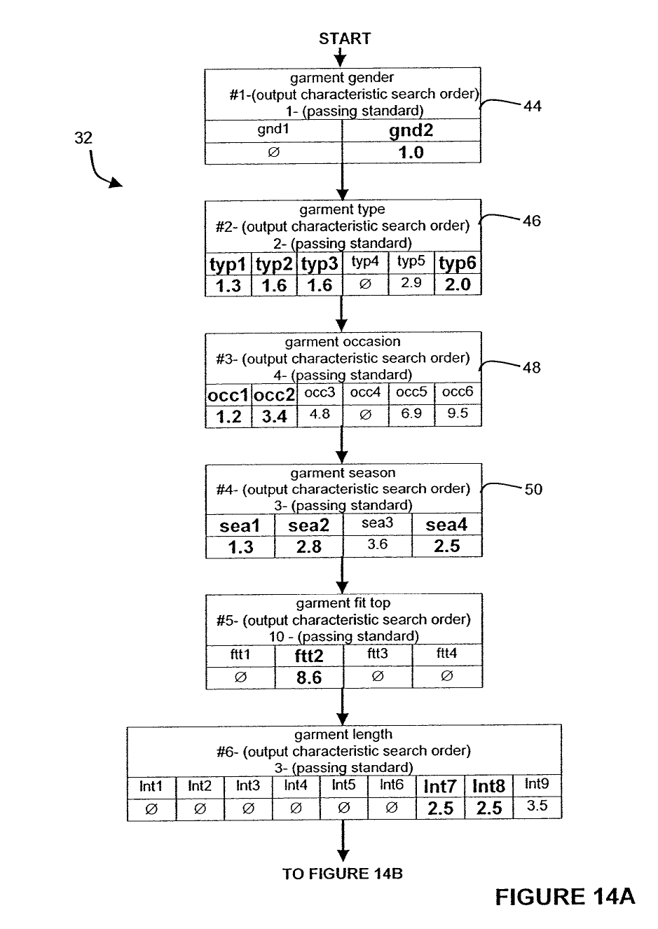

FIGS. 13A to 13E provide an example using the problem of fashion for each of search order, passing criteria, and categorized output characteristic values which are used to form the individualized search engine. In the figures, the left-most column identifies the output characteristic category, the second column represents a designated search order for each of the characteristic categories, the third column represents the “output characteristic values” from the advice engine, and the fourth column represents provided “passing standards.” For example, the “garment occasion” category is the third priority to be considered in the search. The passing standard for the “garment occasion” category is “4,” which rules out garments which are for “occ3,” “occ5,” and “occ6.”

Similarly, for the “garment color tone” characteristic category, the search priority is an “8,” indicating that it will be the eight characteristic considered. The passing standard is “5,” which result in “tne1”=light, and “tne2”=bold being excluded.

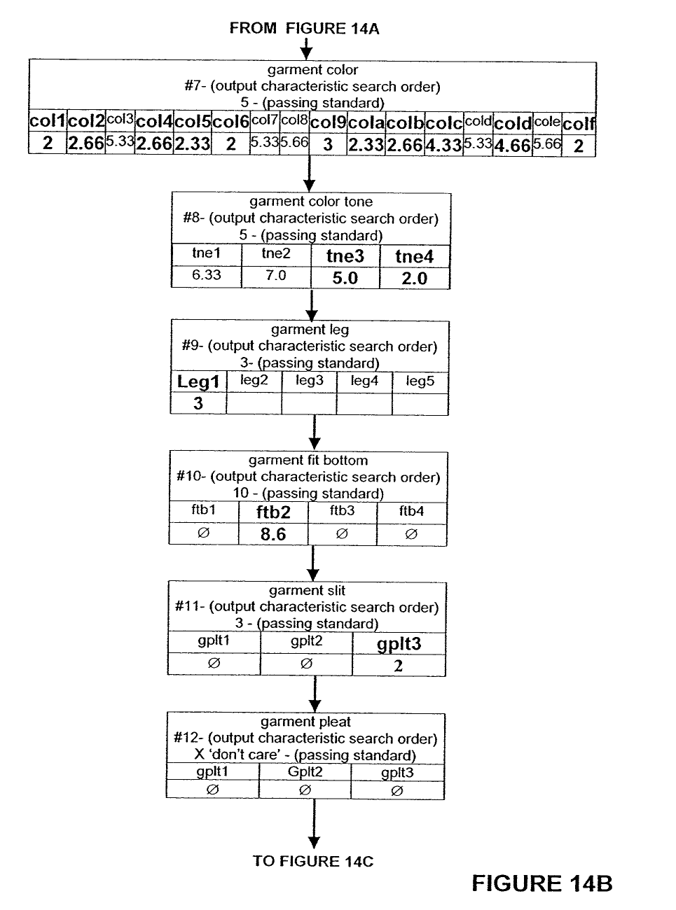

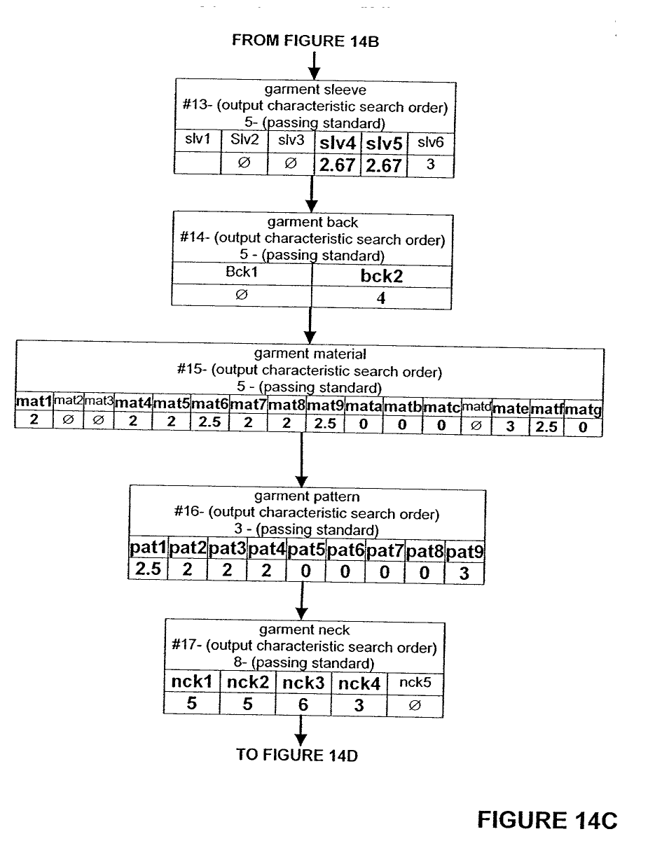

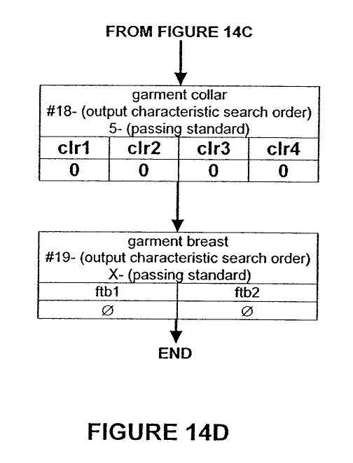

FIGS. 14A to 14D illustrates the individualized branched path search which was formed from the information in FIGS. 13A to 13E. Consistent with FIGS. 13A to 13E, the “garment gender” characteristic category 44 is searched first, followed by the “garment type” category 46. Thereafter, “garment occasion” 48 and then “garment season” 50 are searched, all in accordance with the “search order” column in FIGS. 13A to 13E.

In FIGS. 14A to 14D, the bolded characteristic variations indicate ones which meet the “passing standard” for that characteristic. Thus, for the “garment occasion” block, only “occ1” and “occ2” are bolded in view of the indicated passing standard of “3.” These bolded characteristics indicated the possible valid paths that can be taken through the search level. The non-bolded characteristics are considered to be excluded from the possible paths which may be taken through the search level.

This individualized search engine 32 of FIGS. 14A to 14D queries the characterized inventory database 34, accumulating the output characteristic values for its corresponding path. The characterized inventory that does not map directly to the path dictated by the search engine accumulates a penalty for every non-matching stage. The result of the search engine's query is a score for each inventory item that represents how well it maps to the optimal output characteristics.

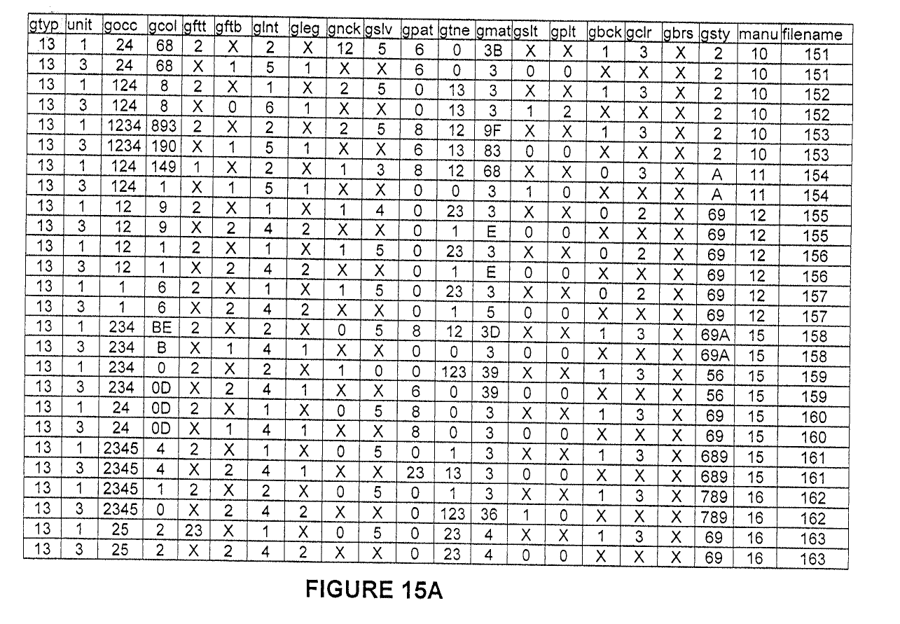

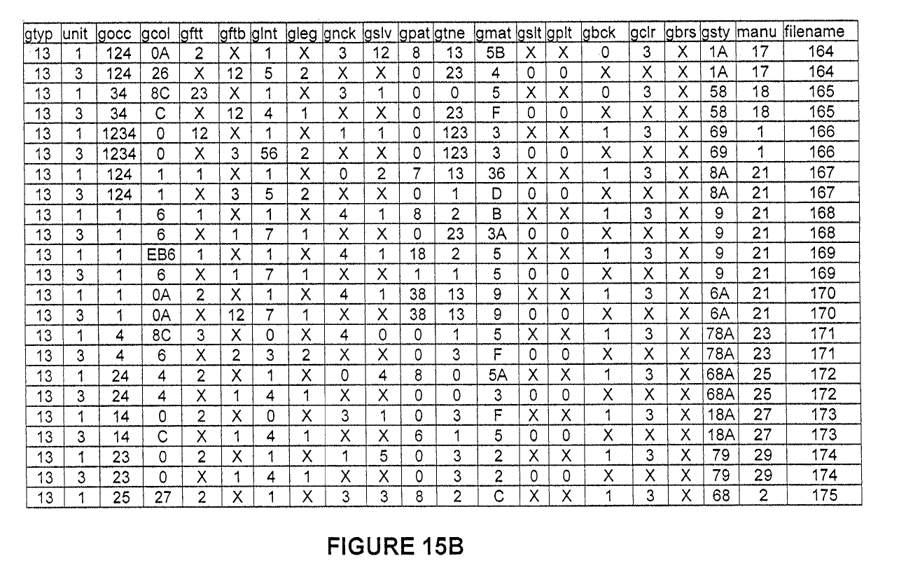

FIG. 15A and 15B illustrate a characterized inventory database which may be queried by the search engine 32 of FIGS. 14A to 14D. (In these figures, the number “0” represents a “don't care” or “no effect” priority, and the number “9” represents an “exclude this characteristic entirely” indication.) For example, examining the second item in the inventory, starting from the “garment type” characteristic 46, it can be seen in FIG. 15A that all of the garments in the inventory are type 1 and type3, which satisfies the “garment type” characteristic 46. For the next characteristic to be checked, “garment occasion,” the second item in FIG. 15A is a type 2 or type 4, which meets the criteria. In this manner, the garments in inventory are queried by the search engine 32, and a prioritized inventory selection 36 is provided.

Because of the efficient structure of the advice engine 10 and the search engine 12 of the present invention, an advice system and object locating methodology is provided which is quick and flexible. The system of the present invention is also scalable, and can support the addition of numerous rules on an ongoing basis as the system is improved to provide increasingly more detailed advice. Further, because of its simplicity, the present invention can support to addition or changes in input and output variable (for example, as additional garment and accessory items are added).

As can be appreciated from the foregoing description of the present invention, customization of rules for individual user or e-tailer's needs (i.e., an e-tailer may want to increase the likelihood that a certain garment is recommended), as well as an ability to add and change different rules as seasons and trends change, can be readily accommodated. Changes in fashion trends can be reflected in the priorities given to each characteristic/input variable combination; and weights given to the input variables can be used make further refinements as fashion trends shift the emphasis to different features. Changes in search order as well as the passing criteria can also be used to alter the advice given by advice engine 10, and the garments selected by selection methodology 12.

It can also be appreciated that because of the architecture of the present invention, additions and deletions from the inventory database are simple and easy to make.

The present invention is particularly suitable to be implemented in a conventional personal computer, web server, or the like.

As can be appreciated from the foregoing, the system and method of the present invention, as illustrated in the network based automation of apparel advice and selection embodiment, is fast, efficient, expandable, scaleable, maintainable, reusable and suitable for solving a wide variety of other complex, real world problems.

It is to be understood that the method and apparatus of the present invention, while described in the context of a retail fashion example, is equally applicable and suitable for use in a wide variety of other areas. For example, the present invention can be used in specifying and selecting components in the electronics industry based upon user-supplied required features, performance and cost. Other applications or uses of the present invention include the other retail scenarios, or any situation where many variables and variations must be applied to many possible choices, in the context of a large body of selection rules. The present invention is likewise capable of incorporating feedback loops to support iterative or real time thinking scenarios.

Attached hereto on pages 51 through 71 is an Appendix of code listings, data and definitions, which provide further detail about the fashion example of the present invention.

It is to be understood that the term “objects” as used herein can refer to anything that has characteristics associated with it. An example might be an army moving across a battlefield and a characteristic might be it's speed, direction, size, etc. Therefore, the term “object” is not meant to be limited solely to physical or inventory objects. The system could be used to just create best parameters for an “object” at any given time.

The present invention has been described above with reference to a fashion embodiment. However, those skilled in the art will recognize that changes and modifications may be made in the above described embodiments without departing from the scope of the invention. For example, the present invention is applicable to any scenario in which a large number of decisional rules, characteristics, and input variables are involved. Furthermore, while the present invention has been described in connection with a specific processing flow, those skilled in the are will recognize that a large amount of variation in configuring the processing tasks and in sequencing the processing tasks may be directed to accomplishing substantially the same functions as are described herein. These and other changes and modifications which are obvious to those skilled in the art in view of what has been described herein are intended to be included within the scope of the present invention.

What is claimed is:

1. A method of providing organized recommendations and or advice to be used in the selection of objects based upon user-supplied profile information, a set of object characteristics, and a set of rules which have been formed by associating a set of variations of the object characteristics with a set of variations of input variables, the method comprising the steps of:
(a) assigning a value to represent the relationship between each associated variation of object characteristic and variation of input variable to form a prioritized rule set;
(b) analyzing the user-supplied profile information to select variations from the set of variations of input variables;
(c) applying the selected input variable variations to the prioritized rule set to obtain a reduced set of prioritized rules; and
(d) processing the reduced set of prioritized rules to generate categorized output characteristic values which represent the provided organized recommendations and or advice.

2. The method of claim 1 further including the step of selecting objects based upon the provided organized recommendations and or advice.

3. A method of providing fashion recommendations and or advice for selecting garments and accessories based upon user-supplied profile information, a set of object characteristics, and a set of rules which have been formed by associating a set of variations of the garment or accessory characteristics with a set of variations of input variables, the method comprising the steps of:
(a) assigning a value to represent the relationship between each associated variation of garment or accessory characteristic and variation of input variable to form a prioritized rule set;
(b) analyzing the user-supplied profile information to select variations from the set of variations of input variables;
(c) applying the selected input variable variations to the prioritized rule set to obtain a reduced set of prioritized rules; and
(d) processing the reduced set of prioritized rules to generate categorized output characteristic values which represent the provided fashion recommendations and or advice .

4. A method of specifying characteristics of objects based upon user-supplied profile information, a set of object characteristics, and a set of rules which have been formed by associating a set of variations of the object characteristics with a set of variations of input variables, the method comprising the steps of:
(a) assigning a value to represent the relationship between each associated variation of object characteristic and variation of input variable to form a prioritized rule set;
(b) analyzing the user-supplied profile information to select variations from the set of variations of input variables;
(c) applying the selected input variable variations to the prioritized rule set to obtain a reduced set of prioritized rules; and
(d) processing the reduced set of prioritized rules to generate categorized output characteristic values which represent the specified object characteristics.

5. A method of forming criteria for selecting objects out of an inventory of available objects based upon user-supplied profile information, a set of object characteristics, and a set of rules which have been formed by associating a set of feasible variations of the object characteristics with a set of feasible variations of input variables, the method comprising the steps of:
(a) assigning a value to represent the relationship between each associated feasible variation of object characteristic and feasible variation of input variable to form a prioritized rule set;
(b) assigning a weight to each variation in the set of feasible variations of input variables;
(c) analyzing the user-supplied profile information to select variations from the set of feasible variations of input variables;
(d) selecting rules from the prioritized rule set which are associated with the selected input variable variations to form a reduced set of prioritized rules; and
(e) processing the reduced set of prioritized rules to generate categorized output characteristic values which represent the criteria for selecting objects.

6. A method for selecting objects from an inventory of objects, each object being described by a set of characteristics and by a value for each characteristic in the set of characteristics, wherein for a particular object the assigned values of the characteristics for that particular object are descriptive thereof, the method comprising the steps of
(a) forming a set of desired characteristic values;
(b) creating a branched path search schema as a function of the desired characteristic values, output characteristic passing criteria, and supplied search order criteria;
(c) evaluating objects from the inventory of available objects according to the branched path search schema; and
(d) ranking the evaluated objects according to how well the object traversed the branched path search schema.

7. The method of claim 6 wherein each characteristic in the set of characteristics has a plurality of feasible values, and the step of creating a branched path search schema comprises the steps of
(a) placing the characteristics from the set of characteristics in a sequence using the supplied search order criteria; and
(b) for each of the sequenced characteristics, applying the output characteristic passing criteria to the corresponding values for the sequenced characteristic, whereby characteristic values which do not satisfy the passing criteria are removed from the branched path search schema for that sequenced characteristic.

8. A method for selecting objects out of an inventory of available objects based upon user-supplied profile information, a set of object characteristics, a set of rules, and comprising the steps of:
(a) identifying object characteristics and variations thereof and input variables which are related to possible user profile information;
(b) formulating a set of rules in an n-dimensional array whose indices are the object characteristics and variations thereof and input variables, and whose element values represent the relationship between these indices;
(c) obtaining user profile information;
(d) applying the user profile information to select a reduced set of input variable indices, which in turn select a reduced set of rules;
(e) processing the element values from the reduced set of rules to generate categorized output characteristic values;
(f) generating an individualized branched path search schema as a function of the categorized output characteristic values, output characteristic passing criteria, and supplied search order criteria;
(g) evaluating objects from the inventory of available objects according to the branched path search schema; and
(h) ranking the evaluated objects according to how well the object traversed the branched path.
